(19) United States
(12) Patent Application Publication
(10) Pub. No.: US 2004/0014629 A1
(43) Pub. Date: Jan. 22, 2004

(54) Process for the production of detergent granules

(75) Inventor: Rafael Lopez, North Brunswick, NJ (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/197,106

(22) Filed: Jul. 17, 2002

(51) Int. Cl. C11D 17/00

(52) U.S. Cl. 510/445; 510/446

(57) ABSTRACT

A process for the production of detergent granules, the process comprising in situ neutralization of liquid non-surfactant organic acid with liquid caustic. In the preferred embodiment of the process, the liquid dosing is from the top of the mixer. In the most preferred embodiment of the process, the resulting detergent granules, optionally processed further and mixed with additional ingredients, are eventually compacted into detergent tablets. Advantageously, by virtue of employing the inventive process for making tablets, the need for post-dosing acetate or carbonate is significantly reduced or eliminated.

### FIELD OF THE INVENTION

The present invention relates to a process for the production of detergent compositions by a non-spray drying process.

### BACKGROUND OF THE INVENTION

Traditionally, detergent powders were produced by spray drying. The spray drying process, however, was both capital and energy intensive and the products were quite bulky, having a relatively low bulk density.

The desire for powders with higher bulk densities led to the development of processes which employ mainly mixing, without the use of spray drying. These mixing techniques offer great flexibility in producing powders of various compositions from a single plant, by post-dosing various components after an initial granulation stage. In the early stages of this process development, the resultant powders had fairly high bulk densities, which is desirable for some product forms. More recently, various techniques were described for utilizing non-spray drying processes which result in low to medium bulk density.

Appel et al. (U.S. Pat. Nos. 5,133,924, 5,164,108 and 5,282,996) and Bortolotti et al. (U.S. Pat. No. 5,160,657) describe a non-spray drying process of making detergent granules, including possible in situ neutralization of an anionic surfactant precursor. WO99/00475 describes adding some inorganic acid together with the liquid acid precursor of the anionic surfactant, and a solid neutralizing agent in order to obtain a lower bulk density product. WO00/37605 discloses a process in which an organic (non-surfactant) acid is used in combination with a carbonated neutralising agent to provide products with bulk densities below about 600 g/l. U.S. Pat. No. 6,162,784 (Hall et al.) discloses mixing a detergent surfactant and an acid source with an alkaline source to improve the suitability and/or dispersion of the detergent in the laundering solution. Organic or inorganic acid may be used; examples of alkaline source are said to include carbonate or silicate.

Janssen (U.S. Pat. No. 6,310,028) discloses a process for making detergent granules (which are eventually used for making detergent tablets). The process may include neutralization of acetic acid with sodium carbonate in a mixer/granulator, to produce sodium acetate dihydrate or trihydrate, which is a suitable tablet disintegrant aid.

Addison (U.S. Pat. No. 6,274,538) discloses tablets which are dispersed by means of gas entrapped within detergent ingredients which gas may be formed by including acid and alkyl within the detergent granule which react upon the contact with water to produce a gas. Gordon (EP 0 838 519 and U.S. Pat. No. 6,093,688), Lammers et al. (U.S. Pat. No. 6,242,403) and Janssen (U.S. Pat. No. 6,310,028) disclosed various detergent tablets containing sodium acetate. WO 01/10995 discloses co-granules of acetate and carbonate for use in the detergent tablets.

### SUMMARY OF THE INVENTION

The invention includes a process for the production of detergent granules, the process comprising dosing to a high speed mixer starting liquid and solid ingredients comprising:

(a) from about 5 to about 30% by weight of the total starting ingredients, of a liquid acid precursor of a non-soap anionic surfactant,

(b) from about 1 to about 9%, by weight of the total starting ingredients, of a liquid organic non-surfactant acid,

(c) from about 0.5 to about 5%, by weight of the total starting ingredients, of a caustic solution; and

(d) from about 50 to about 80%, by weight of the total starting ingredients, of solid ingredients.

In the preferred embodiment of the process, the liquid dosing is from the top of the mixer.

In the most preferred embodiment of the process, the resulting detergent granules, optionally processed further and mixed with additional ingredients, are eventually compacted into detergent tablets. Due to the beneficial granule properties obtained by the inventive process (easily compactable, yet not too sticky), it was possible to reduce compaction forces drastically, which in turn produced a more porous tablet, leading to strong tablets having a satisfactory dissolution in washing machine. Furthermore, by virtue of employing the inventive process for making tablets, the need for post-dosing acetate or carbonate is significantly reduced or eliminated.

### BRIEF DESCRIPTION OF THE DRAWINGS

FIG. 1 is a front perspective view of a typical mixer that may be employed according to the present invention.

FIG. 2 is a schematic cross-sectional view of the mixer of FIG. 1 taken along lines 2-2.

FIG. 3 is a front perspective view of a mixer employed in a preferred embodiment of the present invention.

FIG. 4 is a schematic cross-sectional view of the mixer of FIG. 3 taken along lines 4-4.

### DETAILED DESCRIPTION OF THE INVENTION

Except in the operating and comparative examples, or where otherwise explicitly indicated, all numbers in this description indicating amounts of material or conditions of reaction, physical properties of materials and/or use are to be understood as modified by the word “about.” All amounts are by weight of the total starting ingredients, unless otherwise specified.

It should be noted that in specifying any range of concentration, any particular upper concentration can be associated with any particular lower concentration.

For the avoidance of doubt the word “comprising” is intended to mean “including” but not necessarily “consisting of” or “composed of.” In other words, the listed steps or options need not be exhaustive.

“Liquid” as used herein means that a continuous phase or predominant part of the composition or of the ingredient is liquid and that a composition or an ingredient is flowable at 20° C. (i.e., suspended solids may be included).

“Caustic Solution” means a 40-60% (wt/wt) aqueous solution of sodium or potassium hydroxide. Sodium or potassium hydroxide do not fall within “solid ingredients” definition herein.

“Non-surfactant Acid Salt” or “Non-surfactant Salt Formed in Situ” and its amounts described herein include non-hydrated, partially hydrated and fully hydrated forms of the salt.

“Acetate” or “Acetic Acid Salt” and its amounts described herein include non-hydrated, partially hydrated and fully hydrated forms of the salt.

Liquid Acid Precursor of an Anionic Non-Soap Surfactant

Essentially any liquid acid precursor of an anionic non-soap surfactant is suitable. The liquid acid precursor of an anionic surfactant may be selected from linear alkyl benzene sulphonic acids, alpha-olefin sulphonic acids, internal olefin sulphonic acids, fatty acid ester sulphonic acids and combination thereof, as well as the acid precursors of alkyl ether sulphates. In all cases, these materials preferably have on average in the aliphatic moiety thereof, from 8 to 24 carbon atoms. The process of the invention is especially useful for producing compositions comprising alkyl benzene suphonates by reaction of the corresponding alkyl benzene sulphonic acid, for instance Dobanoic acid ex Shell.

Preferred alkylbenzene sulfonic acid useful in the subject process includes that with an alkyl portion which is straight chain or branched chain, preferably having from 10 to 18, most preferably 10 to 16 carbon atoms. Alkylbenzene sulfonic acid which is predominantly straight chain is preferred because it is more easily biodegraded.

Another preferred class of anionic surfactants are primary or secondary alkyl sulphates. These surfactants can be obtained by sulphation of the corresponding primary or secondary alcohols, followed by neutralization. Because the acid precursors of alkyl sulphates are chemically unstable, they are not commercially available and they have to be neutralized as quickly as possible after their manufacture. The process of the present invention is especially suitable for incorporating alkyl sulphate surfactants into detergent powders because it involves a very efficient first mixing step wherein the anionic surfactant precursor and alkali are brought into contract with one another. In this first step a quick and efficient neutralization reaction is effected whereby the decomposition of the alkyl sulphuric acid is kept at a minimum.

Preferred alkyl sulfuric acid useful in the subject process includes that with an alkyl portion which is straight chain or branched chain, preferably having from about 8 to about 24 carbon atoms, more preferably from about 10 to about 20 carbon atoms, more preferably still from about 12 to about 18 carbon atoms. The alkyl chains of the alkyl sulfuric acids preferably have an average chain length of from about 14 to about 16 carbon atoms. The alkyl chains are preferably linear. Alkyl sulfuric acids are typically obtained by sulfating fatty alcohols produced by reducing the glycerides of fats and/or oils from natural sources, especially from tallow or coconut oil.

The anionic surfactant acids useful in the subject invention process may also be combinations of alkylbenzene sulfonic acid and alkyl sulfuric acid, whether mixed together or added during the process separately. Combinations having a ratio of alkylbenzene sulfonic acid to alkyl sulfuric acid of from about 20:80 to about 80:20 are preferred; those having a ratio of from about 40:60 to about 69:40 are more preferred.

The anionic surfactant acid precursors preferably have a water content of less than about 0.3% more preferably less than about 0.1%.

The amount of anionic surfactant acid precursor employed in the inventive process is from 5% to 30%, preferably from 10% to 20%, most preferably, in order to attain detergent granules having optimum stickiness and disintegration, from 12 to 18%.

Liquid Non-Surfactant Organic Acid

The liquid non-surfactant organic acid may comprise one or more liquid organic acids which are compatible with the anionic surfactant precursor. Typically, the liquid non-surfactant organic acid is selected from carboxylic acids having less than 10 carbon atoms, preferably less than 8 carbon atoms, more preferably selected from the group consisting of formic acid, acetic acid, tert-butyl acetic acid, propanoic acid, butanoic acid. Acetic acid is most preferred, especially when the resulting detergent granules are used for the production of the detergent tablets. The in situ formation of acetate according to the present invention is advantageous for the production of tablets since in the typical production of tablets employing acetate (typically, sodium acetate) as a disintegrant, the bulk of the acetate is added in a separate post-dosing step (after the processing in a high-speed and a moderate speed mixer). Sodium acetate, however, is difficult to handle on a commercial scale due to dust generation and caking. On the other hand, when bulk pre-neutralised sodium acetate salt is added to a mixer (instead of being post-dosed), it results in too high solids to liquids ratio, so that no other solids, e.g. carbonate, can be added within the mixer.

The in-situ formed acetate in the inventive process avoids the bulk acetate handling problems of the post-dosing step and maximizes the tablet making efficiency. Furthermore, by virtue of employing liquid acid and liquid caustic, increased amounts of carbonate may be added within the mixer, thus minimising or even eliminating the need for post-dosing of carbonate as well as post-dosing acetate.

In a preferred embodiment of the inventive process, the liquid non-surfactant organic acid is pre-mixed with the anionic non-soap surfactant acid precursor and the mixture is fed into the high speed mixer through the same nozzle. Such pre-mixing reduces the viscosity of the anionic precursor, without the need to heat it up, and also ensures better distribution of the two ingredients within the detergent granule.

The amount of the liquid non-surfactant organic acid is from 1 to 9%, preferably in order to attain tablets with optimum disintegration at a minimum of post-dosed acetate, from 4 to 8%, more preferably at least 5%.

The weight ratio of liquid acid surfactant precursor to the liquid organic acid is in the range from 1.5:1 to 10:1, preferably from 1.7:1 to 5:1, and most preferably in order to attain best granulation, best powder properties and to minimize stickiness from 2:1 to 3.5:1.

Caustic Solution

Essentially any caustic solution is suitable for use in the present invention. The preferred caustic solution, due to its commercial availability, is a 40-60% wt/wt, preferably 50% wt./wt., sodium hydroxide solution. Due to a relatively short residence time in the mixer and due to the fact that large amounts of total liquid acid are present (the anionic surfactant precursor acid and the liquid organic non-surfactant acid), a liquid caustic is employed in the present invention in order to ensure that the neutralization occurs to the full extent, within the relatively short amount of time available in the mixer. Under-neutralization of the acid, especially acetic acid, leads to vinegar odor. To ensure that the neutralization takes place to the full extent, it is necessary to employ a liquid caustic, since the liquid caustic/liquid acid neutralization reaction occurs faster than solid alkali/liquid acid neutralization reaction.

The amount of the liquid caustic employed in the present invention depends on the total amounts of the acids (surfactant precursor and organic non-surfactant) that are employed and is generally in the range of from 0.5 to 5%, preferably from 1 to 3%, most preferably from 1 to 2%.

Solid Ingredients

A solid alkaline neutralizing agent is preferably present to ensure complete neutralization and to provide the solid bulk. The preferred solid alkaline neutralizing agent is carbonate, because it also functions as a builder, in particular soda ash and, especially preferred is light soda ash (synthetic) or mined soda ash or dense soda ash, to optimize detergent granule properties. Other suitable alkaline neutralizing agents include but are not limited to bicarbonate, sesquicarbonates, burkeite and mixtures thereof. If the alkaline neutralizing agent is also capable of being a builder, it is preferably present in excess, so that it is not all used up in neutralization, but some remains to serve as a builder in the detergent granules.

The solid alkaline neutralizing agent is generally included in the range of from 10 to 50%, preferably from 20 to 40% and, most preferably, in order to achieve full neutralization and to have sufficient excess to function as a builder, from 25 to 40%.

Another preferred solid starting ingredient is aluminosilicate, e.g. zeolite. Crystalline and amorphous aluminosilicate are suitable as well as mixed crystalline and amorphous aluminosilicate and layered silicates. The zeolite used in most commercial particulate detergent compositions is zeolite A. Advantageously, however, maximum aluminum-zeolite P (zeolite MAP may be used as described in claims U.S. Pat. Nos. 5,374,370 and 5,512,266 incorporated by reference herein). Zeolite MAP is an alkyl metal aluminosilicate of the P type having a silicone to aluminum ratio not exceeding 1.5 preferably not exceeding 1.33 and more preferably not exceeding 1.07. Aluminosilicate is generally included in an amount of from 5 to 50%, preferably from 10 to 40% and most preferably in order to provide sufficient solids and the builder function, from 20 to 40%.

Other solid starting ingredients may be present, including for example, organic or inorganic builders.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-di- and trisuccinates, carboxymethyloxysuccinates, carboxymethyloxymalonates, dipicolinates, hydroxyethyliminodiacetates, alkyl- and alkenylmalonates and succinates; and sulphonated fatty acid salts. A copolymer of maleic acid, acrylic acid and vinyl acetate is especially preferred as it is biodegradable and thus environmentally desirable. This list is not intended to be exhaustive.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %. Citrates can also be used at lower levels (e.g. 0.1 to 5 wt %) for other purposes. The builder is preferably present in alkali metal salt, especially sodium salt form.

The total of starting solid ingredients is in the range from 50 to 80% preferably from 60 to 75% and most preferably in order to attain optimum granulation from 65 to 70%.

Non-Surfactant Salt Formed In-Situ

The preferred non-surfactant salt formed in-situ in the inventive process is acetate, especially sodium acetate. This is especially preferred when the resulting granules are used for the tablet manufacture.

The amount of non-surfactant salt is generally in the range of from 2 to 15%, by weight of the resulting detergent granules. Preferably, in order to minimize excessive stickiness, yet not to have granules that are too dry, the amount is in the range of from 3 to 12%, by weight of the granules, most preferably from 4 to 10% in order to obtain granules that are neither too sticky nor too dry.

Optional Additional Starting Ingredients

Preferably, the starting ingredients include a nonionic surfactant, generally in an amount from 1 to 15%, preferably, in order to attain optimum binding of the ingredients in the granule, from 2 to 10%, most preferably from 3 to 8%. Preferably, the nonionic surfactant is liquid, so that it does serve as an additional binder in the granule formation.

As is well known, the nonionic surfactants are characterized by the presence of a hydrophobic group and an organic hydrophilic group and are typically produced by the condensation of an organic aliphatic or alkyl aromatic hydrophobic compound with ethylene oxide (hydrophilic in nature). Typical suitable nonionic surfactants are those disclosed in U.S. Pat. Nos. 4,316,812 and 3,630,929, incorporated by reference herein.

Usually, the nonionic surfactants are polyalkoxylated lipophiles wherein the desired hydrophile-lipophile balance is obtained from addition of a hydrophilic poly-lower alkoxy group to a lipophilic moiety. A preferred class of nonionic detergent is the alkoxylated alkanols wherein the alkanol is of 9 to 20 carbon atoms and wherein the number of moles of alkylene oxide (of 2 or 3 carbon atoms) is from 3 to 20. Of such materials it is preferred to employ those wherein the alkanol is a fatty alcohol of 9 to 11 or 12 to 15 carbon atoms and which contain from 5 to 8 or 5 to 9 alkoxy groups per mole. Also preferred is paraffin-based alcohol (e.g. nonionics from Huntsman or Sassol).

Exemplary of such compounds are those wherein the alkanol is of 10 to 15 carbon atoms and which contain about 3 to 12 ethylene oxide groups per mole, e.g. Neodol® 25-9 and Neodol® 23-6.5, which products are made by Shell Chemical Company, Inc. The former is a condensation product of a mixture of higher fatty alcohols averaging about 12 to 15 carbon atoms, with about 9 moles of ethylene oxide and the latter is a corresponding mixture wherein the carbon atoms content of the higher fatty alcohol is 12 to 13 and the number of ethylene oxide groups present averages about 6.5. The higher alcohols are primary alkanols.

Another subclass of alkoxylated surfactants which can be used contain a precise alkyl chain length rather than an alkyl chain distribution of the alkoxylated surfactants described above. Typically, these are referred to as narrow range alkoxylates. Examples of these include the Neodol-1® series of surfactants manufactured by Shell Chemical Company.

Other useful nonionics are represented by the commercially well-known class of nonionics sold under the trademark Plurafac® by BASF. The Plurafacs® are the reaction products of a higher linear alcohol and a mixture of ethylene and propylene oxides, containing a mixed chain of ethylene oxide and propylene oxide, terminated by a hydroxyl group. Examples include C₁₃-C₁₅ fatty alcohol condensed with 6 moles ethylene oxide and 3 moles propylene oxide, C₁₃-C₁₅ fatty alcohol condensed with 7 moles propylene oxide and 4 moles ethylene oxide, C₁₃-C₁₅ fatty alcohol condensed with 5 moles propylene oxide and 10 moles ethylene oxide or mixtures of any of the above.

Another group of liquid nonionics are commercially available from Shell Chemical Company, Inc. under the Dobanol® or Neodol® trademark: Dobanol® 91-5 is an ethoxylated C₉-C₁₁ fatty alcohol with an average of 5 moles ethylene oxide and Dobanol® 25-7 is an ethoxylated C₁₂-C₁₅ fatty alcohol with an average of 7 moles ethylene oxide per mole of fatty alcohol.

In the process of this invention, preferred nonionic surfactants include the C₁₂-C₁₅ primary fatty alcohols or alkyl phenols with relatively narrow contents of ethylene oxide in the range of from about 6 to 9 moles, and the C₉ to C₁₁ fatty alcohols ethoxylated with about 5-6 moles ethylene oxide.

Another class of nonionic surfactants which can be used in accordance with this invention are glycoside surfactants. Glycoside surfactants suitable for use in accordance with the present invention include those of the formula:

RO—(R¹O)_{y}—(Z)ₓ

wherein R is a monovalent organic radical containing from about 6 to about 30 (preferably from about 8 to about 18) carbon atoms; R¹ is a divalent hydrocarbon radical containing from about 2 to 4 carbons atoms; O is an oxygen atom; y is a number which can have an average value of from 0 to about 12 but which is most preferably zero; Z is a moiety derived from a reducing saccharide containing 5 or 6 carbon atoms; and x is a number having an average value of from 1 to about 10 (preferably from about 1½ to about 10).

A particularly preferred group of glycoside surfactants for use in the practice of this invention includes those of the formula above in which R is a monovalent organic radical (linear or branched) containing from about 6 to about 18 (especially from about 8 to about 18) carbon atoms; y is zero; z is glucose or a moiety derived therefrom; x is a number having an average value of from 1 to about 4 (preferably from about 1½ to 4). Nonionic surfactants which may be used include polyhydroxy amides as discussed in U.S. Pat. No. 5,312,954 to Letton et al. and aldobionamides such as disclosed in U.S. Pat. No. 5,389,279 to Au et al., both of which are hereby incorporated by reference into the subject application.

Mixtures of two or more of the nonionic surfactants can be used.

The weight ratio of acid precursor(s) of anionic surfactant(s) to any optional nonionic surfactants, will normally be from 20:1 to 1:20. However, this ratio may be, for example, 15:1 or less, 10:1 or less, or 5:1 or less of acid precursors of anionic surfactant(s) to nonionic surfactants(s). Ratios in the range from 5:1 to 2:1 a of acid precursors of anionic surfactant(s) to nonionic surfactants(s) are preferred.

Another preferred optional starting ingredient is a fatty acid which upon in-situ neutralization in the high speed mixer becomes soap. Suitable fatty acids have the chain lengths of from 10 to 18 carbon atoms, with the preferred fatty acid being stearic acid, generally employed in an amount of from 0.1 to 10%, preferably from 0.5 to 7%, most preferably from 0.5 to 5%. In the most preferred embodiment stearic acid is premixed with nonionic surfactant, to attain the most uniform mixing in the mixer.

Typically, the amounts of pre-neutralized acids included in the starting ingredients is below 10%, most preferably below 5% and, optimally, below 2% by weight of the starting ingredient.

Another preferred starting ingredient is sodium carboxymethyl cellulose, an anti-redeposition agent, typically included in the range of from 0 to 5%, preferably from 0 to 3%. In the processes of the present invention that produce detergent tablets, sodium carboxymethylcellulose is also preferably added in the post-dosing step, to attain optimum tablet disintegration. In the post-dosing step, the amount of sodium carboxymethylcellulose is generally in the range of from 0 to 10%, by weight of the finished tablet composition, preferably from 0 to 8%, most preferably from 0 to 5%.

Solids to Liquid Surfactant Ratio

Traditionally, increasing solids to liquid surfactant ratio in a high speed mixer was problematic because the process is too fast and the resulting granules are too fine. By virtue of employing a liquid organic non-surfactant acid in the inventive process, the solids level can be increased. The starting solids to the starting liquid surfactant weight ratio in the inventive process is generally in the range of from 1:1 to 6:1, preferably from 1:1 to 5:1, most preferably in order to optimize the process and to produce granules that are neither too fine nor too sticky, from 2:1 to 5:1. For calculating this ratio, “surfactant” includes all liquid synthetic non-soap surfactants and precursors thereof (so includes nonionic surfactants, if any, anionic surfactant precursor but not stearic acid or sodium stearate).

Process

The process of the present invention employs a high speed mixer for making detergent granules. The process may be continuous or batch. Suitable high mixers provide a high energy stirring input and achieve thorough mixing in a very short time. The preferred high speed mixer is Lodige CB30 or Lodige CB100 (commonly known as Recycler). Other types of high-speed mixers having a comparable effect on detergent powders can be also contemplated. For instance a Shugi (Trade Mark) Granulator or a Drais (Trade Mark) K-TTP 80 may be used.

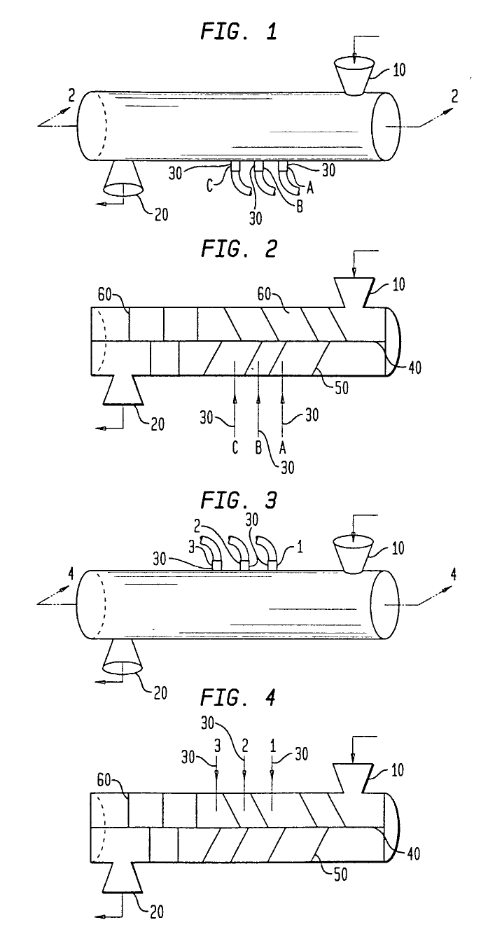

Referring to FIGS. 1-4 hereof, the high speed mixer essentially consists of a large, static horizontal cylinder. In the middle, it has a rotating shaft 40 along the horizontal axis with various blades and mixing tools (50, 60) mounted thereon. The mixer is designed to quickly and effectively combine liquid and solid ingredients. It can be rotated at tip speeds between 100 and 2500 rpm, dependent on the degree of mixing and the particle size desired. The blades and tools on the shaft provide a thorough mixing action of the solids and the liquids.

The mean residence time in the high speed mixer is somewhat dependent on the rotational speed of the shaft, the position of the blades and other process parameters. The typical residence time is from about 1 second to about 1 minute, preferably from about 5 seconds to about 45 seconds, most preferably to achieve effective mixing at optimum energy input from 5 to 30 seconds.

In a high speed mixer, the solid starting material is typically input through funnel 10 (the solid falling by gravity), whereas liquids are dosed through nozzles 30 with the direction of the flow typically from the funnel 10 towards the nozzles 30 and eventually towards the exit opening, equipped e.g. with a reverse hopper 20 to collect the granules. Typically, at least three nozzles are present for dosing liquids, preferably at least three. In the preferred embodiment the nozzles are equipped with additional spray nozzles. In the preferred embodiment according to the present invention, the liquid dosing nozzles are positioned at the top of the mixer, as shown in FIGS. 3 and 4. It has been found that the input of both liquids and solids from the top of the mixer results in optimum neutralization reaction speed and optimum granulation process and detergent granule properties. In an even more preferred embodiment of the present invention, nozzle 1 is utilized for caustic solution, nozzle 2 is utilized for nonionic or, more preferably, nonionic/stearic acid mixture, nozzle 3 is utilized for anionic surfactant precursor/liquid non-surfactant organic acid. More than three total nozzles may be present, but in any event, this order of addition relative to the solids input is preferably followed. As demonstrated in Examples 1-10 herein, the input of liquid starting ingredient in such an order with respect to the direction of the solid material flow optimizes the granulation process. The inputting of both solid and liquid starting materials from the top of the mixer prevents accumulation of the material upstream because neutralization of liquid non-surfactant organic acid occurs almost immediately. If the liquid organic acid is fed through the bottom of the mixer and, especially, through the first nozzle (e.g., nozzle A in FIG. 1), it may accumulate too much solid (due to the fast neutralization reaction) upstream of the liquid injection nozzles and cause instability of the mixer power (power draw oscillation) which may result in the shut-down of the mixer. According to the most preferred embodiment of the present invention, the non-surfactant organic acid is pre-mixed with anionic surfactant acid precursor, to ensure the best distribution of both the surfactant and the in-situ formed salt in the detergent granules.

Optional Process Steps

In the preferred embodiment of the inventive process, the detergent granules resulting from the mixing in a high speed mixer, are fed into a second mixer, preferably a moderate speed mixer, most preferably Lodige KM300 mixer or Lodige KM10000 or Lodige 13500, also referred as Lodige Ploughshare. Such mixers are equipped with mixing shaft with “plough” blades and choppers. The granules exiting from the second mixer may be dried or further processed in a fluid bed apparatus or in an air lift, various ingredients may be sprayed onto the granules in fluid bed apparatus.

A layering agent may be employed (e.g. silicate, aluminosilicate or other fine powder) between the mixers or in the second mixer or after the granules exit from first or the second mixer.

In one preferred embodiment, especially suitable for continuous processes, oversized granules and/or fines are recycled and fed to the high speed mixer along with the starting ingredients.

Tableting

The inventive process is particularly advantageous as part of the process of making detergent tablets. Thus, the granules resulting from the high speed mixer and optionally moderate speed mixer and fluid bed dryer, may be optionally be post-dosed with additional ingredients and then compressed into tablets. This embodiment of the process preferably employs acetic acid as a liquid organic non-surfactant acid and sodium hydroxide solution, which results in formation of sodium acetate in-situ which, in turn, acts as a disintegrant in the detergent tablet. The most preferred processes for making detergent tablets according to the present invention do not employ any substantial amounts of additional sodium acetate in post-dosing steps of the process. Furthermore, in the preferred processes, no additional carbonate is post-dosed. Specifically, in a preferred embodiment of the inventive process at least 90% of all sodium acetate and/or carbonate present in the tablets is present in the detergent granules formed in a high speed mixer, preferably at least 95% and most preferably at least 98%. The amount of post-dosed acetate and/or carbonate in the preferred process of making tablets is less than 15%, by weigh of the tablet preferable no more than 10%, most preferably below 10%, optimally in the range of 0-5%. In the most preferred processes according to the present invention for forming detergent tablets, substantially no additional disintegrant is added in a post-dosing steps even if the disintegrant is other than acetate. Surprisingly, the disintegration of the resulting tablets, especially aged tablets, is optimised if, in addition to the in-situ formed acetate, the inventive process includes post-dosing sodium carboxymethylcellulose, as described above.

Additional post-dosed ingredients may be included, especially ingredients that are not ideally suitable for processing in the high speed mixer, e.g. enzymes, bleaches, bleach precursors, fragrances, additional zeolite. Preferably, the tablet comprises at least 80% of the base powder granules, by weight of the tablet, preferably from 82% to 97%, more preferably from 87% to 97%, most preferably from 94% to 97% (the need for post-dosing acetate and carbonate being virtually eliminated by the inventive process).

Tableting entails compaction of a particulate composition. A variety of tableting machinery is known, and can be used. Generally it will function by stamping a quantity of the particulate composition which is confined in a die.

By virtue of employing the inventive process, tablets may be made using lower compaction pressures. In general, a tension exists in tablet manufacture between compaction pressure and optimum tablet solubility: sufficient compaction pressure must be used to provide a tablet which does not break easily during transportation and in handling, yet the tablet must not be so strongly compacted as not to dissolve sufficiently early in the laundry cycle. In the inventive process, due to the unique properties of the granules obtained, the granules compact easily (so, lower compaction pressure may be used), yet the tablet is both non-friable and dissolves satisfactorily in the laundry process. Although any suitable compaction pressure may be used, preferably, in order to obtain a tablet which is non-friable in storage and in handling, yet dissolves early enough in the washing machine, the compaction pressure is in the range of from 0.3 to 2.0 Bars (at 1 atmosphere), preferably from 0.3 to 1.5 Bars, most preferably, from 0.3 to 1.0 Bars. These compaction forces are associated with tablet strength and dissolution times as follows: the dissolution times (measured as described in the Examples below) are in the range of 1 to 5 minutes, preferably from 1 to 4 and most preferably from 1 to 3 minutes; The tablet strength (measured as described in the Examples below) is in the range of 15 to 60 Newton, preferably from 15 to 40 Newton and more preferably from 20 to 30 Newton.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature. This will of course supply heat to the tableting machinery, but the machinery may be heated in some other way also.

If any heat is supplied, it is envisaged that this will be supplied conventionally, such as by passing the particulate composition through an oven, rather than by any application of microwave energy.

The preferred laundry detergent granules may further include one or more well-known laundry ingredients, optical brighteners, anti-redeposition agents, fluorescent dyes, perfumes, soil-release polymers, colorant, enzymes, bleaches, bleach precursors, buffering agents, antifoam agents, UV-absorbers, etc.

Bactericides, e.g. tetrachlorosalicylanilide and hexachlorophene, fungicides, dyes, pigments (water dispersible), preservatives, e.g. formalin, ultraviolet absorbers, anti-yellowing agents, such as sodium carboxymethyl cellulose, pH modifiers and pH buffers, color safe bleaches, perfume and dyes and bluing agents such as Iragon Blue L2D, Detergent Blue 472/372 and ultramarine blue can be used.

Also, soil release polymers and cationic softening agents may be used.

The list of optional ingredients above is not intended to be exhaustive and other optional ingredients which may not be listed, but are well known in the art, may also be included in the composition.

The following specific examples further illustrate the invention, but the invention is not limited thereto.

The following ingredients have been used in the Examples:

Linear Alkylbenzene Sulfonic Acid Alkylbenzene sulfonic acid which is predominantly

straight chain 10 to 16 carbon atoms (“LAS”),

Na LAS: Sodium salt of Linear Alkylbenzene Sulfonic Acid

Glacial Acetic Acid (“HOAC”)

Sodium Hydroxide Caustic Solution (“NAOH”)

Nonionic: Dobanol® 25-7 is an ethoxylated C₁₂-C₁₅ fatty alcohol with an average of 7 moles ethylene oxide per mole of fatty alcohol.

Sodium Carboxymethyl Cellulose (“SCMC”)

Stearic Acid (“Stearic”)

Na stearate: Sodium stearate

Soda Ash: mined Sodium Carbonate

Zeolite A24 (“Zeolite”)

### EXAMPLES 1-10

TABLE 1
STARTING INGREDIENTS

| | % by weight of starting ingredients | | | | | | | | | |
|---|---|---|---|---|---|---|---|---|---|---|
| | | | | | | | | | | Solid/Liquid |
| Example | | | | Non | | | Soda | | Miscellaneous | Surfactant |
| Number | LAS | HOAc | NaOH | Ionic | SCMC | Stearic | Ash | Zeolite | & water | ratio |
| Example 1 | 13.1 | 5.1 | 1.1 | 4.5 | 1.5 | 1.0 | 48.5 | 20.0 | 5.2 | 3.98 |
| Example 2 | 18.0 | 7.8 | 1.5 | 5.6 | 2.2 | 1.5 | 11.1 | 43.0 | 9.3 | 2.39 |
| Example 3 | 17.5 | 7.8 | 1.4 | 5.4 | 2.2 | 1.3 | 12.2 | 43.0 | 9.2 | 2.51 |
| Example 4 | 13.1 | 5.1 | 1.1 | 4.5 | 1.5 | 1.0 | 43.0 | 25.0 | 5.7 | 3.95 |
| Example 5 | 15.6 | 5.1 | 1.1 | 4.5 | 1.7 | 0.9 | 34.4 | 30.0 | 6.7 | 3.29 |
| Example 6 | 14.8 | 5.1 | 1.3 | 4.3 | 1.6 | 0.9 | 35.3 | 31.0 | 5.7 | 3.55 |
| Example 7 | 14.7 | 5.1 | 1.3 | 4.3 | 1.6 | 0.9 | 35.3 | 31.0 | 5.8 | 3.57 |
| Example 8 | 14.7 | 5.1 | 1.5 | 4.3 | 1.6 | 0.9 | 35.3 | 31.0 | 5.6 | 3.57 |
| Example 9 | 14.6 | 5.9 | 1.6 | 4.5 | 1.6 | 0.9 | 34.0 | 30.0 | 6.9 | 3.43 |
| Example | 14.6 | 5.9 | 1.6 | 4.5 | 1.6 | 0.9 | 34.1 | 29.8 | 7.0 | 3.43 |
| 10 | | | | | | | | | | |

TABLE 2
PROCESS CONDITIONS
Lodige CB30 Recycler was used. Process conditions were within
the scope of the invention in all examples. In Examples 1-3 the liquids
were fed from the bottom of the mixer; in Examples 4-10 liquids were
fed from the top of the mixer. In Examples 8-10, fines were recycled.

| | | | |
|---|---|---|---|
| | | Recycler | Mass flow |
| Example | Recycler | power draw | Rate |
| Number | rpms | (kw) | (kg/hour) |

| | | | |
|---|---|---|---|
| Example 1 | 1500 | 9.0-25.0 | 682 |
| Example 2 | 1500 | 9.0-25.0 | 545 |
| Example 3 | 1500 | 9.0-25.0 | 545 |
| Example 4 | 1500 | 8.0-12.0 | 682 |
| Example 5 | 1730 | 7.0-12.0 | 755 |
| Example 6 | 1730 | 6.0-8.0 | 755 |
| Example 7 | 1730 | 5.0-8.0 | 755 |
| Example 8 | 1730 | 5.0-7.0 | 755 |
| Example 9 | 1730 | 8.0-11.0 | 755 |
| Example 10 | 1730 | 6.0-8.0 | 755 |

It can be seen from Table 2 that the power draw oscillation was within substantially more narrow range in Examples 4-10 when the liquids were fed from the top of the mixer compared to Examples 1-3 when the liquids were fed from the bottom of the mixer.

TABLE 3
GRANULE COMPOSITION

| | | In Situ | | | | | | |
|---|---|---|---|---|---|---|---|---|
| Example | Na | Na | Non | | Na | | | Miscellaneous |
| Number | LAS | Acetate | Ionic | SCMC | Stearate | Soda Ash | Zeolite | & water |
| Example 1 | 13.50 | 6.3 | 4.50 | 1.01 | 1.08 | 48.50 | 20.00 | 5.11 |
| Example 2 | 18.50 | 7.2 | 5.55 | 1.40 | 1.63 | 11.70 | 43.00 | 11.02 |
| Example 3 | 18.00 | 7.5 | 5.40 | 1.40 | 1.41 | 12.60 | 43.00 | 10.69 |
| Example 4 | 13.50 | 6.3 | 4.50 | 1.00 | 1.10 | 43.00 | 25.00 | 5.60 |
| Example 5 | 16.00 | 5.8 | 4.50 | 1.10 | 1.08 | 34.40 | 30.00 | 7.12 |
| Example 6 | 15.10 | 6.4 | 4.30 | 1.10 | 1.08 | 35.30 | 31.00 | 5.72 |
| Example 7 | 15.10 | 6.3 | 4.30 | 1.10 | 1.08 | 35.30 | 31.00 | 5.82 |
| Example 8 | 15.10 | 6.3 | 4.30 | 1.10 | 1.08 | 25.30 | 31.00 | 15.82 |
| Example 9 | 15.00 | 7 | 4.50 | 1.10 | 1.08 | 30.00 | 34.00 | 7.32 |
| Example 10 | 15.00 | 7 | 4.50 | 1.10 | 1.08 | 30.00 | 34.10 | 7.22 |

### EXAMPLES 11-16

Tablets were made using granules produced by Examples 5-10, with granule compositions detailed in Table 3. The granules were fed to Ploughshare (ex. Lodige), conditioned in a fluid bed, the resulting granules named “Base Powder” in the Tables below, additional ingredients were post-dosed—mixed with the Base Powder. Portions of 36 to 40 g of the compositions were made into cylindrical tablets with a diameter of 44 mm and a height between 21 to 25 mm, using a Grasby Specac labscale tablet press with varying compaction forces. The strength of the tablets was determined by the force, expressed in Newtons, needed to break the tablet, as measured by MTS Synergie 100 testing instrument.

The speed of dissolution of the tablets was measured by a test procedure in which a tablet is placed on a plastic sieve with 2 mm mesh size which was immersed in 9 liters of tap water at 20C and rotated at 200 rpms. The water conductivity was monitor over a period 20 of about 5 to 10 minutes or until it reach a constant value. The time for break up and dissolution of the tablet t90 was taken as the time for change of the water conductivity to reach 90% of its final value. This was also confirmed by visual observation of material remaining on the rotating sieve.

The results that were obtained are summarized in Table 4.

TABLE 4

| Example Number | 11A | 11B | 11C | 12 | 13 | 15 | 16 |
|---|---|---|---|---|---|---|---|
| Base Powder Com- | 5 | 5 | 5 | 6 | 7 | 9 | 10 |
| position Example No. | | | | | | | |
| In situ Sodium Acetate | 5.97 | 5.97 | 6.90 | 6.51 | 6.36 | 6.96 | 6.96 |
| (by weight of tablet) | | | | | | | |

% by weight of the tablet

| | | | | | | | |
|---|---|---|---|---|---|---|---|
| Base Powder | 85.4 | 85.4 | 98.5 | 93.1 | 90.9 | 87 | 87 |
| Post-Dosed | | | | | | | |
| Ingredients | | | | | | | |
| Sodium Carbonate | 0.0 | 6.5 | 0.0 | 0.0 | 0.0 | 0.0 | 0.0 |
| Sodium Acetate | 13.1 | 6.6 | 0.0 | 5.1 | 7.3 | 10 | 10 |
| Sodium Perborate | 1.0 | 1.0 | 1.0 | 1.0 | 1.0 | 1.0 | 1.0 |
| Fragrance | 0.0 | 0.0 | 0.0 | 0.3 | 0.3 | 0.3 | 0.30 |
| Zeolite | 0.5 | 0.5 | 0.5 | 0.5 | 0.5 | 0.5 | 0.5 |
| Fluorescer | 0 | 0 | 0 | 0 | 0 | 0.23 | 0'.23 |
| Tablet strength (N) | 34.8 | 30.3 | 27.3 | 40.0 | 29.0 | 24 | 23.3 |
| Compaction Force | 2.0 | 2.5 | 1.5 | 2 | 1.5 | 0.75 | 0.8 |
| (bars) | | | | | | | |
| T90 (minutes) | 2.08 | 2.34 | 6.39 | 5.11 | 2.49 | 2.36 | 2.37 |
| Tablet Weight (g) | 38.0 | 38.0 | 38.0 | 37.0 | 37 | 38.0 | 38.0 |

In example 14, base powder granules of Example 8 were used to make a tablet. Tablets made with this base powder did not dissolve well. In Examples 14-16, fines from the fluid bed were recycled to the recycler, in the base powder production. It appears that the base powder in Example 14, at the ploughshare stage, was over-worked due to the loss of layering zeolite resulting from the high dust collection suction. Overworked powder results in high t90. This was resolved in successive runs (by closing to some extent the dust collection vent).

The results in Table 4 indicate that reducing the amount of post-dosed sodium acetate and post-dosed carbonate was possible (Example 11B vs. Example 11A; also, Examples 12, is 13, 15 and 16). Compaction forces were not as high as with typically employed in the past (typical compaction force is 2.5-3 bars).

Due to the better control of the granulation process with in-situ neutralized sodium acetate, power draw oscillations in the recycler were less which give better and more consistent granules. Due to the beneficial granule properties (easily compactable, yet not too sticky), it was possible to reduce compaction forces drastically, which in turn produced a more porous tablet. The more porous the faster the water ingress into the tablet, leading to faster dissolution. Yet, the tablet strength was in a satisfactory (above 20 Newtons) range.

### EXAMPLE 17

Example 11 was repeated, but using a blend of base powder granules of Examples 9 and 10. The results that were obtained are summarized in Table 5

TABLE 5

| | % by weight of |
|---|---|
| Tablet Formulation | the tablet |
| Base Powder | 94.7 |
| Sodium Carbonate | 0.0 |
| Sodium Acetate | 0.0 |
| Fragrance | 0.3 |
| Zeolite | 1.0 |
| Fluorescer | 0.2 |
| SCMC | 3.0 |
| Miscellaneous | 0.8 |
| Total | 100.0 |
| Compaction force (bars) | 0.4 |
| Tablet strength (N) | 26.1 |
| T90 (minutes) | 2.5 |
| T90 (minutes) of 3 days | 3.7 |
| old tablet | |
| Tablet Weight, g | 36.0 |

It can be seen from Table 5, that the inventive process resulted in granules which could be compacted using a very low compaction force and having satisfactory tablet strength and dissolution, even after aging, even in the complete absence of post-dosed sodium acetate. Furthermore, the inventive process avoids post-dosing of the carbonate as well.

### EXAMPLE 18

The inventive process was carried out using Lodige Recycler, with the starting ingredients, as detailed in Table 6.

TABLE 6

| STARTING | |
|---|---|
| INGREDIENTS | % |
| Zeolite | 25.0 |
| LAS | 13.1 |
| Nonionic | 4.5 |
| Mined Soda Ash | 43.0 |
| Acetic acid | 5.1 |
| SCMC | 1.5 |
| Stearic Acid | 1.0 |
| Caustic Solution | 1.1 |
| Miscellaneous & Water | 5.7 |
| FINISHED GRANULE | % by weight of |
| COMPOSITION | the granule |
| Zeolite | 25.0 |
| Sodium LAS | 13.5 |
| Nonionic | 4.5 |
| Mined Soda Ash | 43.0 |
| Sodium acetate (in situ) | 7.0 |
| SCMC | 1.0 |
| Sodium Stearate | 1.0 |
| Miscellaneous | Balance to 100 |

### EXAMPLE 18A

Equipment was set to start and when the recycler and ploughshare matched 1500 rpm and 120 rpm, respectively, the solid raw ingredients were set to dose. Once the mass flows of the solid raws matched the set points (mass flow rate at 682 kg/hour), the liquid starting ingredients were set to dose. LAS and acetic acid as well as nonionic and stearic acid were already pre-blended. Caustic soda 50% solution was also added. The amount of caustic was equivalent to the amount needed to neutralize 35% of the LAS being dosed.

Liquids were fed through nozzles as shown in FIGS. 1 and 2:

Result:

After the first run, the flow rate was reduced to 545 kg/hour due to high instability of the recycler. Power draw fluctuation was plus/minus 15 kW and tending up, i.e. 3-18, kW, 7-22, kW, and finally oscillating up to 30 kw (maximum allowed), shutting down the system (apparatus turned itself off). Reducing the flow rate did not resolve the instability but was able to run for longer time before system shut down. Instability means fluctuation on kilowatt drawn due to intermittent accumulation of material causing the mixer to do more work.

### EXAMPLE 18B

The procedure of Example 18 A was then repeated, with modifications:

Recycler RPM 1730

Total mass flow 755 kg/hour

Liquid starting ingredients were dosed from the top of the mixer as shown in FIGS. 3 and 4, with caustic solution being fed through nozzle 1, nonionic/stearic mixture through nozzle 2, and anionic precursor/actetic acid through nozzle 3.

Result:

Kilowatt fluctuation was ±3 kW, in the range of 5-8 kW and stayed at the same level allowing equipment to operate steadily.

It can be seen from comparing the results of Example 18A and 18B, that it is advantageous to input liquids from the top of the mixer.

What is claimed is:

1. A process for the production of detergent granules, the process comprising dosing to a high speed mixer starting liquid and solid ingredients comprising:
(a) from about 5 to about 30% by weight of the total starting ingredients, of a liquid acid precursor of a non-soap anionic surfactant,
(b) from about 1 to about 9%, by weight of the total starting ingredients, of a liquid organic non-surfactant acid,
(c) from about 0.5 to about 5%, by weight of the total starting ingredients, of a caustic solution; and
(d) from about 50 to about 80%, by weight of the total starting ingredients, of solid ingredients.

2. The process of claim 1, wherein the amount of a salt formed in situ in the resultant detergent granules by reaction between the non-surfactant acid and the neutralising agent is from about 2% to about 15%, by weight of the granules.

3. The process of claim 1 wherein the liquid ingredients are dosed from the top of the mixer.

4. The process of claim 3 wherein the direction of the flow of the dosed ingredients within the mixer is from solid ingredients to liquid ingredients.

5. The process of claim 4, wherein the nozzle for dosing the non-surfactant acid is the most distant nozzle from the funnel for solid dozing.

6. The process of claim 1 wherein the weight ratio of the caustic solution to the liquid non-surfactant acid is from about 1.5:1 to about 10:1.

7. The process of claim 1 wherein the residence time in the mixer is from about 1 second to about 1 minute.

8. The process of claim 1 further comprising dosing to the high speed mixer an additional detergent ingredient selected from the group consisting of organic detergent builders, inorganic detergent builders, anti-redeposition actives, soap, fatty acid, nonionic surfactant, and mixtures thereof.

9. The process of claim 1 wherein the weight ratio of total starting solid ingredients to total starting liquid surfactant is from about 1:1 to about 6:1.

10. The process of claim 1 wherein the solid ingredients comprise an alkaline neutralizing agent.

11. The process of claim 1 wherein the alkaline neutralizing agent is a carbonate selected from the group consisting of alkali metal carbonates, bicarbonates, sesquicarbonates, burkeite and mixtures thereof.

12. The process of claim 1 further comprising dosing a nonionic surfactant into the mixer.

13. The process of claim 1 further comprising dosing zeolite into the mixer.

14. The process of claim 1, wherein the anionic acid precursor is selected from the group consisting of acid precursor of an alkylbenzene sulphonate, acid precursor of primary alkyl sulphate, acid precursor of alkyl olefin sulphonate, acid precursor of alkyl ether sulphate and mixtures thereof.

15. The process of claim 1 wherein the non-surfactant liquid acid is acetic acid.

16. The process of claim 1 further comprising feeding the detergent granules to a moderate speed mixer.

17. The process of claim 1 further comprising mixing the detergent granules with an ingredient selected from the group consisting of enzymes, bleaches, bleach precursors, fragrances, builders, and mixtures thereof.

18. The process of to claim 1 further comprising compressing the detergent granules to obtain a detergent tablet.

19. The process of claim 18, wherein the liquid non-surfactant organic acid is acetic acid.

20. The process of claim 19, wherein at least about 90%, by weight of the tablet, of all acetate present in the tablet is a salt of acetic acid formed in situ in the high speed mixer.

21. The process of claim 19, wherein at least about 90%, by weight of the tablet, of all carbonate present in the tablet is the carbonate in the detergent granules.

22. The process of claim 18, wherein the compaction pressure is in the range of from about 0.3 to 2.0 bars.

23. The process of claim 18 further comprising mixing the detergent granules with sodium carboxymethylcellulose.

24. The process of claim 18, wherein the process comprises mixing detergent granules with from about 0% to about 15%, by weight of the tablet, of acetate and/or carbonate.
